(19) United States
(12) Patent Application Publication
(10) Pub. No.: US 2021/0109367 A1
(43) Pub. Date: Apr. 15, 2021

(54) Lens Module

(71) Applicant: AAC Optics Solutions Pte. Ltd., Singapore city (SG)

(72) Inventors: Linzhen Li, Shenzhen (CN); Jiliang Lu, Shenzhen (CN); Gang Li, Shenzhen (CN); Jin Zhang, Shenzhen (CN); Chunxin Gu, Shenzhen (CN)

(21) Appl. No.: 16/885,206

(22) Filed: May 27, 2020

(30) Foreign Application Priority Data
Oct. 15, 2019 (CN) 201910980056.0

(51) Int. Cl. G02B 27/64; G02B 7/09

(52) U.S. Cl. CPC G02B 27/646; G02B 7/09

(57) ABSTRACT

The invention provides a lens module having a housing body, a lens, an installation support frame that fixes the lens, a first base, a second base arranged opposite to the installation support frame, a first driver piece that drives the installation support frame to cause relative displacement of the lens relative to the first base, a second driver piece that drives the installation support frame to cause relative displacement of the lens relative to the second base in a direction perpendicular to the optical axis of the lens. The first base and the second base are fixed opposite in the housing body. In the invention, the lens is fixed through the installation support frame, the first driver piece is used to drive the relative displacement of the lens along its optical axis direction. As a result, the lens module has a simple structure and high production efficiency.

### FIELD OF THE PRESENT DISCLOSURE

The invention relates to the field of optical imaging technology, and in particular to a lens module.

### DESCRIPTION OF RELATED ART

In recent years, with the development of optical imaging technology and the rise of electronic products with imaging functions, optical lenses have been widely used in various electronic products. Generally, the light is irradiated directly from the object side, reaches the image side and by penetrating the lens component in a straight line along the optical axis. The lens component is used to image the object. The lens component generally has an auto focus function (auto focusing) and an optical image stabilization (OIS) function.

The existing lens module utilizes an elastic suspension component to suspend the lens component in a fixation frame, and to cooperate with the magnet provided through the focusing coil to drive lens component to move along the optical axis direction to realize auto focusing of the lens component in the fixation frame. The elastic suspension component also cooperates with the magnet through the anti-shake coil to drive lens component to move along a direction to perpendicular to the optical axis to compensate the shaking of the lens component in the fixation frame. This arrangement makes the structure of the lens module complicated, and the production efficiency reduces accordingly.

Therefore, it is necessary to provide a new lens module to solve the above problems.

### SUMMARY OF THE PRESENT INVENTION

One of the major objectives of the present invention is to provide a lens module enabling stable movement and high efficiency.

To performing the object mentioned above, the lens module includes:

a housing body;

a lens accommodated in the housing body;

an installation support frame fixing the lens;

a first base and a second base arranged opposite to the installation support frame, the first base and the second base being fixed opposite in the housing body;

a first driver piece for driving the installation support frame to cause relative displacement of the lens relative to the first base in an optical axis direction of the lens;

a second driver piece for driving the installation support frame to cause relative displacement of the lens relative to the second base in a direction perpendicular to the optical axis of the lens; wherein

the first driver piece comprises a first magnet fixed to the installation support frame and a first coil fixed opposite to the housing body; the first magnet is magnetized along the optical axis direction of the lens; the first coil is arranged on one end of the first magnet along the optical axis direction; and a thickness direction of winding of the first coil extends along the optical axis direction;

the second driver piece comprises a second magnet fixed to the installation support frame and a second coil fixed opposite to the housing body; the second magnet is magnetized along an a direction that is horizontal and perpendicular to the optical axis direction of the lens; the second coil is arranged on one side of the second magnet along a direction perpendicular to the optical axis; and a thickness direction of the winding of the second coil extends perpendicular to the optical axis.

As an improvement, the lens module further comprises a first metal plate arranged on one side of the first magnet along a direction perpendicular to the optical axis; a projection of the first magnet along the direction perpendicular to the optical axis overlaps with the first metal plate; wherein when the displacement of the lens occurs in the optical axis direction, the force between the first metal plate and the first magnet provides a restoring force that make the lens return to original position.

As an improvement, the lens module further comprises a second metal plate arranged on one side of the second magnet along a direction perpendicular to the optical axis, and the projection of the second magnet direction perpendicular to the optical axis overlaps with the second metal plate; wherein when the displacement of the lens occurs in a direction perpendicular to the optical axis, the force between the second metal plate and the second magnet provides a restoring force that make the lens return to original position.

As an improvement, the installation support frame, the first base, and the second base are sequentially stacked, the second base is fixed to the housing body, a first ball is provided between the first base and the installation support frame, and a second ball is provided between the second base and the first base.

As an improvement, the installation support frame, the second base, and the first base are sequentially stacked, the first base is fixed to the housing body, and a first ball is provided between the first base and the second base, a second ball is provided between the second base and the installation support frame.

As an improvement, a surface of the first base facing the installation support frame is provided with a first track, and the first ball slides in the first track, the surface of the second base facing the first base is provided with a second track, and the second ball slides in the second track.

As an improvement, the lens module further comprises a circuit board, wherein the circuit board is fixed to the housing body, and the first coil and the second coil are both electrically connected with the circuit board.

As an improvement, the housing body comprises a frame part, a bottom plate provided at one end of the frame part, and a cover plate provided at the other end of the frame part, the second base is fixed to the bottom plate.

As an improvement, the circuit board comprises a first part fixed to the frame part, and a second part fixed to the cover plate; the first coil is fixed to the first part, and the second coil is fixed to the second part.

As an improvement, a first accommodation slot and a second accommodation slot are arranged to the installation support frame on both sides of the lens, two of the first magnets are provided, one of the first magnet is embedded in each of the first accommodation slot; two of the second magnets are provided, and one of the second magnet is embedded in each of the second accommodation slot.

### BRIEF DESCRIPTION OF THE DRAWINGS

Many aspects of the exemplary embodiments can be better understood with reference to the following drawings. The components in the drawing are not necessarily drawn to scale, the emphasis instead being placed upon clearly illustrating the principles of the present disclosure.

FIG. 1 is an illustrative structural view of a lens module provided by the first embodiment and the second embodiment of the invention;

FIG. 2 is an illustrative structural view of an exploded state of the lens module provided by the first embodiment;

FIG. 3 is an illustrative structural view of a first perspective of partially exploded state of the lens module provided by the first embodiment;

FIG. 4 is an illustrative structural view of a second perspective of partially exploded state of the lens module provided by the first embodiment;

FIG. 5 is an illustrative structural view of the components installed inside a housing body provided by the first embodiment;

FIG. 6 is an illustrative structural view of the first perspective of the lens in cooperative state with the first base and the second base provided by the first embodiment;

FIG. 7 is an illustrative structural view of the second perspective of the lens in cooperative state with the first base and the second base provided the first embodiment;

FIG. 8 is an illustrative structural view of an exploded state of a lens module provided by the second embodiment;

FIG. 9 is an illustrative structural view of partial exploded state of the first perspective of the lens module provided by the second embodiment;

FIG. 10 an illustrative structural view of partial exploded state of the second perspective of the lens module provided by the second embodiment.

### DETAILED DESCRIPTION OF THE EXEMPLARY EMBODIMENTS

The present disclosure will hereinafter be described in detail with reference to several exemplary embodiments. To make the technical problems to be solved, technical solutions and beneficial effects of the present disclosure more apparent, the present disclosure is described in further detail together with the figure and the embodiments. It should be understood the specific embodiments described hereby are only to explain the disclosure, not intended to limit the disclosure.

The invention is further described below with reference to the drawings and embodiments.

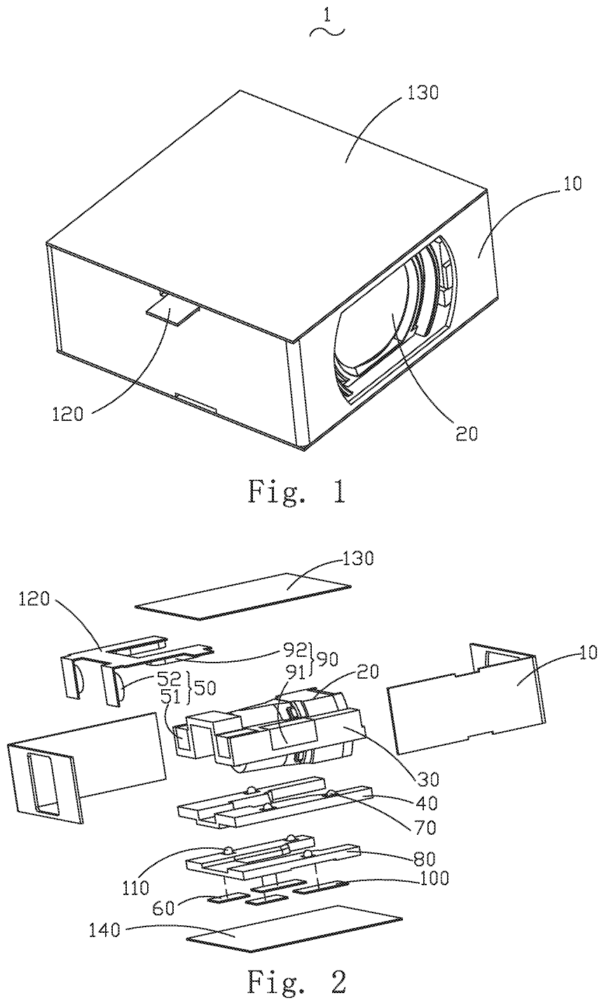

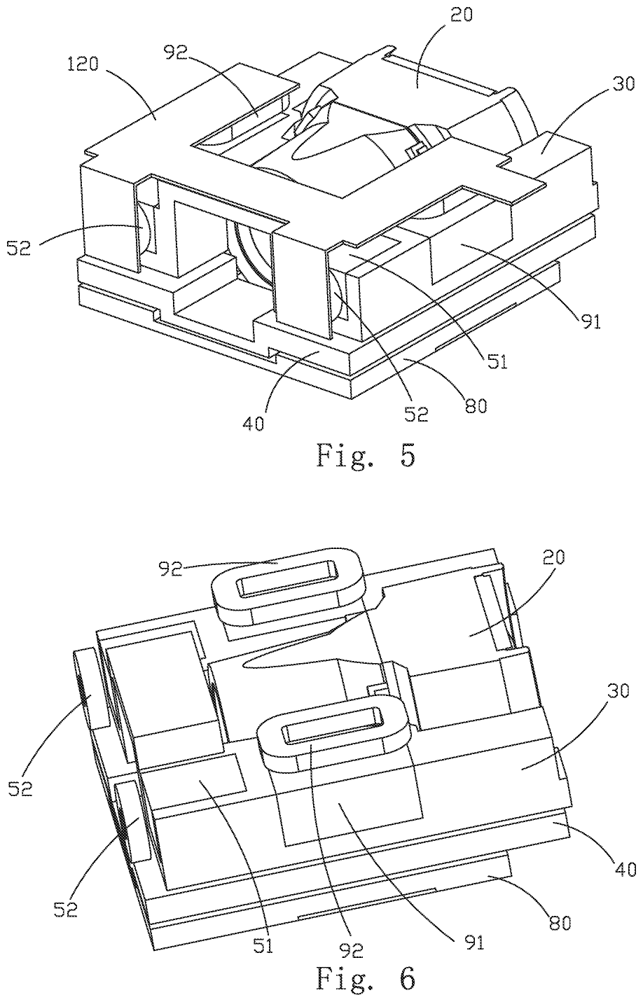

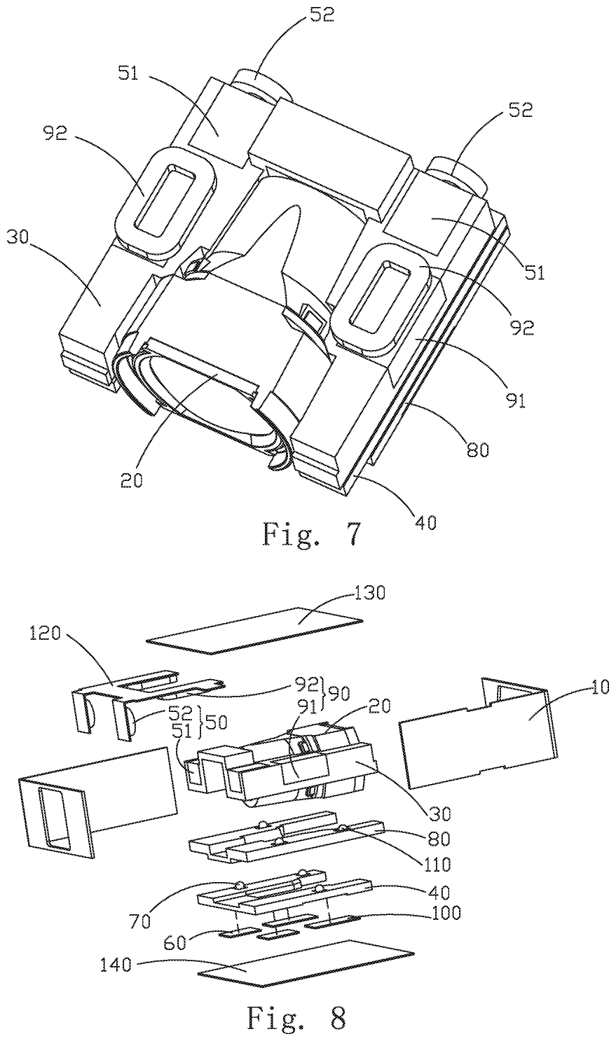

Referring to FIGS. 1-7, the first embodiment of the invention relates to a lens module 1, which comprises a housing body; a lens 20 accommodated in the housing body; an installation support frame 30 which fixes the lens 20; a first base 40 and a second base 80 arranged opposite to an installation support frame 30; a first driver piece 50 which causes the relative displacement of the lens 20 relative to the first base 40 in an optical axis direction of the lens 20 by driving the installation support frame 30; a second driver piece 90 which causes the relative displacement of lens 20 relative to the second base 80 in the direction perpendicular to optical axis of lens 20 by driving installation support frame 30. The first base 40 and the second base 80 are fixed opposite in the housing body. Specifically, the installation support frame 30, the first base 40, and the second base 80 can be in contact with each other through sliding to make the friction force between the two small, so that the installation support frame 30 can achieve effective movement, that is, the lens 20 can achieve effective movement. More specifically, the lens 20 referred to in this embodiment can move in the optical axis direction of the lens 20, that is, move along the length direction of the housing body, so that the auto focusing of the lens 20 can be achieved in the housing body. The lens 20 in this embodiment can move in a direction perpendicular to optical axis of the lens 20 to compensate for the shaking of the lens 20 in a direction perpendicular to optical axis.

Referring to FIG. 2, the lens module 1 further comprises a circuit board 120, the circuit board 120 is fixed in the housing body. Specifically, the first coil 52 and the second coil 92 are both electrically connected with the circuit board 120, so as to provide power to the first coil 52 and the second coil 92.

Wherein, referring to FIGS. 2-7, the first driver piece 50 comprises a first magnet 51 fixed to the installation support frame 30 and a first coil 52 fixed opposite to the housing body. The first magnet 51 is magnetized along the optical axis direction of lens 20, the first magnet 51 is magnetized along the optical axis direction of lens 20, the first coil 52 is arranged at one end of the first magnet 51 along the optical axis direction, and the thickness direction of winding of the first coil 52 extends along the optical axis direction. In specific applications, the electromagnetic force generated by the cooperation of the first coil 52 and the first magnet 51 drives the lens 20 to move in the optical axis direction of the lens 20 to achieve auto focusing of the lens 20 in the housing body. For example, when the polarization direction of magnetic pole of the first coil 52 facing the first magnet 51 and the polarization direction of the magnetic pole of the first magnet 51 are opposite, the installation support frame 30 drives the lens 20 to move forward in the optical axis direction of the lens 20. When the polarization direction of magnetic pole of the first coil 52 facing the first magnet 51 and the polarization direction of the magnetic pole of the first magnet 51 are the same, the installation support frame 30 drives lens 20 to move backward in the optical axis direction of the lens 20.

Further, referring to FIGS. 2-7, the second driver piece 90 comprises a second magnet 91 fixed to the installation support frame 30 and a second coil 92 fixed opposite to the housing body; the second magnet 91 is magnetized along a horizontal direction perpendicular to optical axis direction of the lens 20; the second coil 92 is arranged on one side of the second magnet 91 in a direction perpendicular to the optical axis, and the thickness direction of the winding of the second coil 92 extends along a direction perpendicular to the optical axis In specific applications, in the shooting situation when shaking occurs, the lens 20 may move slightly in the plane perpendicular to the optical axis. At this time, the Lorentz force generated by the cooperation of the second coil 92 and the second magnet 91 drives the lens 20 to move in the opposite direction to compensate vibration amount for obtaining high-definition images.

Compared with the prior art, in the invention installation support frame 30 is arranged to have lens 20 installed in the housing body, makes structure of the lens module 1 simpler; the lens 20 is driven through the first driver piece 50 to undergo relative displacement along the optical axis direction of the lens 20, thus lens 20 can do auto focusing in the housing body; the lens 20 is driven through the second driver piece 90 to undergo relative displacement along a direction perpendicular to optical axis, in order to compensate the shaking of lens 20 in the direction perpendicular to the optical axis; the structure of the lens module 1 is simple, the production efficiency is high, and the image stabilization and auto focusing can be effectively realized.

Incidentally, referring to FIGS. 2-7, the installation support frame 30 comprises a first mounting plate, a second mounting plate, and a connection plate connecting the first mounting plate and the second mounting plate; the first mounting plate and the second mounting plate are respectively installed at both ends of the connection plate. The first mounting plate and the second mounting plate are symmetrical according to the middle line of the connection plate, so that an accommodation opening is formed between the first mounting plate and the second mounting plate. The lens 20 passes through the accommodation opening and is installed in the installation support frame 30, so that the first mounting plate and the second mounting plate are located respectively at both sides of the lens 20, and the connection plate is located at one end of the lens 20. Specifically, the first mounting plate and the second mounting plate are both provided with the first accommodation slot, and the first accommodation slots are respectively located on one end of the first mounting plate and the second mounting plate near the first coil 52, and two of the first magnets 51 are provided, one first magnet 51 is embedded in each first accommodation slot. Two first coils 52 are provided and correspond to two first magnets 51 one by one, so as to install two first magnets 51 on installation support frame 30. Correspondingly, the first mounting plate and the second mounting plate are both provided with the second accommodation slot, the second accommodation slots are respectively located on the side of the first accommodation slot near the lens 20, and two second magnets 91 are provided, a second magnet 91 is embedded in each of the second accommodation slots, and two of the second coils 92 are provided and arranged corresponding one to one to two second magnets 91 so as to install two second magnets 91 on the installation support frame 30. In this way, the first driver piece 50 and the second driver piece 90 can drive the lens 20 to move within the housing body, so that the lens 20 can achieve effective optical image stabilization and auto focusing to obtain high-quality images.

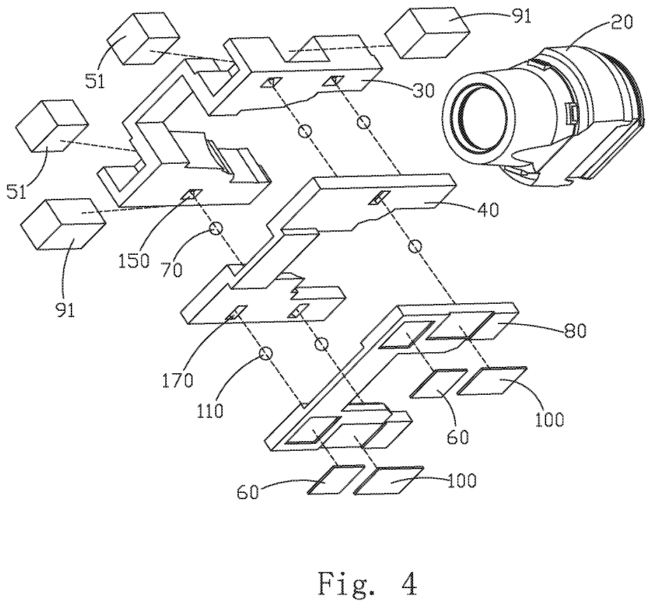

As an improvement of this embodiment, please refer to FIG. 2 and FIG. 4, the lens module 1 further comprises a first metal plate 60 arranged at one side of the first magnet 51 along a direction perpendicular to the optical axis, the projection of the first magnet 51 along the direction perpendicular to the optical axis overlaps with the first metal 60 plate. When displacement of lens 20 occurs in the optical axis direction, the magnetic force between the first metal plate 60 and the first magnet 51 can provide a restoring force to reset the lens 20 so that the lens 20 moves back to its initial position.

As an improvement of this embodiment, please refer to FIG. 2 and FIG. 4, the lens module 1 further comprises a second metal plate 100 arranged on one side of the second magnet 91 along a direction perpendicular to the optical axis, and the projection of the second magnet 91 along a direction perpendicular to the optical axis overlaps with the second metal plate 100. When displacement of the lens 20 occurs along a direction perpendicular to the optical axis, the magnetic force between the second metal plate 100 and the second magnet 91 can provide restoring to reset the lens 20 so that the lens 20 moves back to its initial position.

As an improvement of this embodiment, please refer to FIGS. 2-7, the installation support frame 30, the first base 40, the second base 80 are sequentially stacked. The second base 80 is fixed on the housing body. In particular, the first metal plate 60 and the second metal plate 100 can be fixed on the second base 80. For example, the first mounting slot and the second mounting slot can be arranged concavely on the side of the second base 80 away from the installation support frame 30. It can be understood that the number of the first mounting slot is two, two first mounting slots and two first magnets 51 are arranged corresponding to each other one to one; the number of the second mounting slot is two, two second mounting slots and two second magnets 91 are arranged corresponding to each other one to one. Further the first metal plate 60 is embedded in the first mounting slot, and the second metal plate 100 is embedded in the second mounting slot, so that two first metal plates 60 and two first magnets 51 are provided in one-to-one correspondence with each other; two second metal plates 100 and two second magnets 91 are provided in one-to-one correspondence with each other; then the magnetic force between the first metal plate 60 and the first magnet 51 or between the second metal plate 100 and the second magnet 91 can facilitate the effective reset of lens 20 after moving.

For a better implementation method, please refer to FIGS. 2-4, a first ball 70 is provided between the first base 40 and the installation support frame 30, and a second ball 110 is provided between the second base 80 and the first base 40. It should be noted that the attraction force between the first metal plate 60 and the first magnet 51, and between the second metal plate 100 and the second magnet 91 can facilitate the pressing of the first ball 70 and the second ball 110, respectively between the first base 40 and installation support frame 30, between the second base 80 and the first base 40. Wherein, the surface of the first base 40 facing the installation support frame 30 is provided with a first track, the first ball 70 can slide in the first track, and the surface of the second base 80 facing the first base 40 is provided with the second track, the second ball 110 can slide in the second track, which can facilitate the effective movement of installation support frame 30 relative to the first base 40 and that of the first base 40 relative to the second base 80, this is beneficial to the effective movement of lens 20.

Of course, please refer to FIGS. 2-4, the first track can also be arranged on the installation support frame 30, preferably, the installation support frame 30 and the first base 40 cooperate to form the first track. For example, the first track can be formed by combining a first guide slot 150 and a second guide slot 160. Specifically, the first guide slot 150 is arranged on a surface of the installation support frame 30 facing the first base 40; the second guide slot 160 is arranged on the surface of the first base 40 facing the installation support frame 30; the first ball 70 is embedded between the first guide slot 150 and the second guide slot 160, which can restrict the first ball 70 from leaving the first track, so that the first ball 70 can be used to reduce the friction force between the installation support frame 30 and the first base 40.

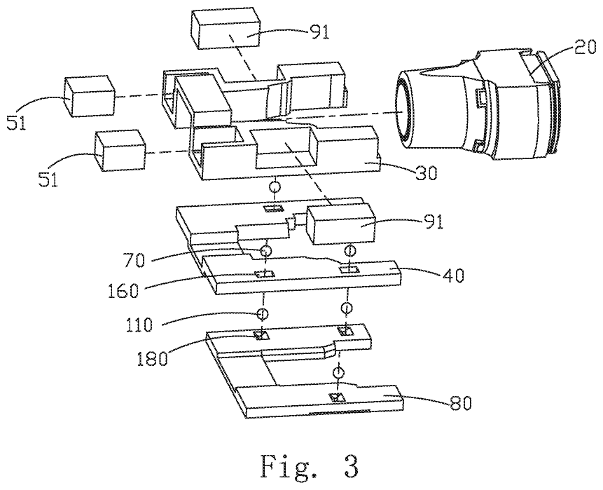

Preferably, please refer to FIG. 3 and FIG. 4, three second guide slots 160 are provided, two of the second guide slots 160 are provided on one side of lens 20, that is, two second guide slots 160 are located on bottom side of one of the first mounting plate and the second mounting plate, the other one of the second guide slot 160 is arranged on the other side of lens 20, that is, the other second guide slot 160 is located on bottom side of one of the first mounting plate and the second mounting plate. More specifically, the second guide slot 160 provided separately is located between two second guide slots 160 provided in pairs in a direction perpendicular to the optical axis, a first ball 70 is embedded in each of the second guide slot 160. Preferably, the connection line of three first balls 70 are isosceles triangle. In this design, three first balls 70 can form a stable three-point support structure for the installation support frame 30, and only three first balls 70 can form a stable support for the installation support frame 30, the structure is simplified and the complexity of lens module 1 is reduced.

Similarly, referring to FIG. 3 and FIG. 4, a second track can also be arranged on the first base 40, preferably, the first base 40 and the second base 80 combine to form the second track. For example, the second track can be formed by combining a third guide slot 170 and a fourth guide slot 180; the third guide slot 170 is provided on the surface of the first base 40 facing the second base 80, the fourth guide slot 180 is provided on the surface of the second base 80 facing the first base 40, and the second ball 110 is embedded between the third guide slot 170 and the fourth guide slot 180 for limiting the second ball 110 from the second track, so that the second ball 110 can be used to reduce the friction force between the first base 40 and the second base 80.

Preferably, please refer to FIG. 2-4, the number of the fourth guide slot 180 provided is three, two of the fourth guide slots 180 are provided on one side of the lens 20, the other fourth guide slot 180 is arranged on the other side of lens 20, the fourth guide slot 180 provided separately is located between two fourth guide slots 180 provided in pair in a direction perpendicular to the optical axis, and a second ball 110 is embedded in each of the fourth guide slot 180. Preferably, the connection line of the three second balls 110 are isosceles triangle. In this design, three second balls 110 can form a stable three-point support structure for the first base 40, and only three second balls 110 are needed to form a stable support for the first base 40, which simplifies the structure, reduces the complexity of lens module 1.

Preferably, the housing body comprises a frame part 10, a bottom plate 140 provided at the bottom end of the frame part 10, and a cover plate 130 provided at the top end of the frame part, the second base 80 is fixed on the bottom plate 140. Specifically, two first mounting slots and two second mounting slots are arranged on the bottom surface of the second base 80, two first metal plates 60 and two second metal plates 100 are respectively embedded at backside of two first mounting slots and two second mounting slots, the second base 80 is fixed on the bottom plate 140, so that the two first metal plates 60 and two second metal plates 100 are effectively fixed in two first mounting slots and two second mounting slots.

In particular, please refer to FIG. 1 and FIG. 2, the circuit board 120 comprises a first part fixed to the frame part 10 and a second part fixed to the cover plate 130, preferably, the first part and the second part are perpendicular to each other, wherein the first coil 52 is fixed on the surface of the first part near the first magnet 51, and the second coil 92 is fixed on the surface of the second part near the second magnet 91.

More specifically, please refer to FIG. 1 and FIG. 2, an opening is provided on the frame part 10 or the cover plate 130, then the first part or the second part can be extended through the opening to the outside of the housing body and then connected to an external power source, so that the lens module 1 can be connected to an external power source and obtain sufficient power.

Please refer to FIGS. 8-10, the second embodiment of the invention relates to a lens module 1. The second embodiment is improved on the basis of the first embodiment. The main improvements include an installation support frame 30, a second base 80, and a first base 40 are stacked sequentially, and the first base 40 is fixed to the housing body, specifically, the first base 40 is fixed onto the bottom plate 140, thus, the first metal plate 60 and the second metal plate 100 can be fixed on the first base 40. A first ball 70 is provided between the first base 40 and the second base 80, and a second ball 110 is provided between the second base 80 and the installation support frame 30. Wherein, the surface of the first base 40 facing the second base 80 is provided with a first track, the first ball 70 slides in the first track, the surface of the second base 80 facing the installation support frame 30 is provided with a second track, and the second ball 110 slides in the second track.

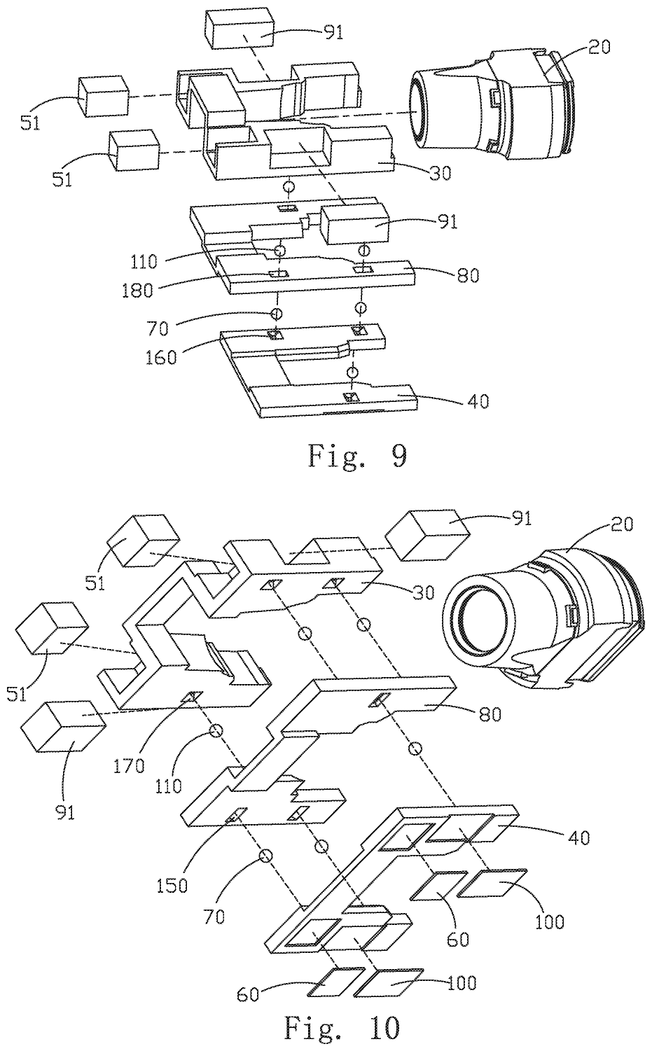

Of course, please refer to FIG. 9 and FIG. 10, the first track can also be arranged on the first base 40, preferably, the first base 40 and the second base 80 cooperate to form the first track; for example, the first track may be formed by combining the first guide slot 150 and the second guide slot 160. Specifically, the first guide slot 150 is arranged on the surface of the second base 80 facing the first base 40, the second guide slot 160 is arranged on the surface of the first base 40 facing the second base 80, the first ball 70 is embedded between the first guide slot 150 and the second guide slot 160, so that the first ball 70 can be restricted from leaving the first track, then the first ball 70 can be used to reduce the friction force between the first base 40 and the second base 80.

Preferably, please referring to FIGS. 8-10, the number of the second guide slots 160 provided is three, two of the second guide slots 160 are provided on one side of the lens 20, and the other second guide slot 160 is provided on the other side of the lens 20. More specifically, the second guide slot 160 which is separately provided is located between two second guide slots 160 arranged in pair in the direction perpendicular to the optical axis, and a first ball 70 is embedded in each of the second guide slot 160. Preferably, the connection line of three first balls 70 are isosceles triangle. In this design, three first balls 70 can form a stable three-point support structure for the installation support frame 30, and only three first balls 70 can form a stable support for the installation support frame 30, the structure is simplified and the complexity of lens module 1 is reduced.

Similarly, please refer to FIG. 9 and FIG. 10, the second track can also be arranged on installation support frame 30, preferably, the second base 80 and installation support frame 30 cooperate to form the second track. For example, the second track slot 170 can be formed by combining a third guide slot 170 and a fourth guide slot 180. The third guide slot 170 is arranged on the surface of the installation support frame 30 facing the second base 80, and the fourth guide slot 180 is arranged on the surface of the second base 80 facing the installation support frame 30. The second ball 110 is embedded between the third guide slot 170 and the fourth guide slot 180, which is used to restrict the second ball 110 from leaving the second track, so that the second ball 110 can be used to reduce the friction force between the second base 80 and the installation support frame 30.

Preferably, please referring to FIGS. 8-10, the number of the fourth guide slot 180 provided is three, two of the fourth guide slots 180 are provided on one side of lens 20, the other fourth guide slot 180 is provided on the other side of lens 20, and the fourth guide slot 180 which is separately provided is located between two fourth guide slots 180 provided in a pair in a direction perpendicular to the optical axis, and a second ball 110 is embedded in each of the fourth guide slot 180. Preferably, the connection line of the three second balls 110 are isosceles triangle. In this design, three second balls 110 can form a stable three-point support structure for the first base 40, and only three second balls 110 are needed to form a stable support for the first base 40, which simplifies the structure, reduces the complexity of lens module 1.

Therefore, please refer to FIGS. 8-10. The first ball 70 can be used to reduce the friction force between the first base 40 and the second base 80, and the second ball 110 can be used to reduce the friction force between the second base 80 and the installation support frame 30. Furthermore, it can facilitate the effective movement of the installation support frame 30 relative to the second base 80 and that of the second base 80 relative to the first base 40.

The other structures of this embodiment are the same as those of the first embodiment, and are not described again.

It is to be understood, however, that even though numerous characteristics and advantages of the present exemplary embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A lens module comprising:
a housing body;
a lens accommodated in the housing body;
an installation support frame fixing the lens;
a first base and a second base arranged opposite to the installation support frame, the first base and the second base being fixed opposite in the housing body;
a first driver piece for driving the installation support frame to cause relative displacement of the lens relative to the first base in an optical axis direction of the lens;
a second driver piece for driving the installation support frame to cause relative displacement of the lens relative to the second base in a direction perpendicular to the optical axis of the lens; wherein
the first driver piece comprises a first magnet fixed to the installation support frame and a first coil fixed opposite to the housing body; the first magnet is magnetized along the optical axis direction of the lens; the first coil is arranged on one end of the first magnet along the optical axis direction; and a thickness direction of winding of the first coil extends along the optical axis direction;
the second driver piece comprises a second magnet fixed to the installation support frame and a second coil fixed opposite to the housing body; the second magnet is magnetized along an a direction that is horizontal and perpendicular to the optical axis direction of the lens; the second coil is arranged on one side of the second magnet along a direction perpendicular to the optical axis; and a thickness direction of the winding of the second coil extends perpendicular to the optical axis.

2. The lens module as described in claim 1 further comprising a first metal plate arranged on one side of the first magnet along a direction perpendicular to the optical axis; a projection of the first magnet along the direction perpendicular to the optical axis overlaps with the first metal plate; wherein when the displacement of the lens occurs in the optical axis direction, the force between the first metal plate and the first magnet provides a restoring force that make the lens return to original position.

3. The lens module according to claim 2 further comprising a second metal plate arranged on one side of the second magnet along a direction perpendicular to the optical axis, and the projection of the second magnet direction perpendicular to the optical axis overlaps with the second metal plate;
wherein
when the displacement of the lens occurs in a direction perpendicular to the optical axis, the force between the second metal plate and the second magnet provides a restoring force that make the lens return to original position.

4. The lens module as described in claim 1, wherein the installation support frame, the first base, and the second base are sequentially stacked, the second base is fixed to the housing body, a first ball is provided between the first base and the installation support frame, and a second ball is provided between the second base and the first base.

5. The lens module as described in claim 1, wherein the installation support frame, the second base, and the first base are sequentially stacked, the first base is fixed to the housing body, and a first ball is provided between the first base and the second base, a second ball is provided between the second base and the installation support frame.

6. The lens module as described in claim 4, wherein a surface of the first base facing the installation support frame is provided with a first track, and the first ball slides in the first track, the surface of the second base facing the first base is provided with a second track, and the second ball slides in the second track.

7. The lens module as described in claim 4 further comprising a circuit board, wherein the circuit board is fixed to the housing body, and the first coil and the second coil are both electrically connected with the circuit board.

8. The lens module as described in claim 7, wherein the housing body comprises a frame part, a bottom plate provided at one end of the frame part, and a cover plate provided at the other end of the frame part, the second base is fixed to the bottom plate.

9. The lens module as described in claim 8, wherein the circuit board comprises a first part fixed to the frame part, and a second part fixed to the cover plate; the first coil is fixed to the first part, and the second coil is fixed to the second part.

10. The lens module as described in claim 3, wherein a first accommodation slot and a second accommodation slot are arranged to the installation support frame on both sides of the lens, two of the first magnets are provided, one of the first magnet is embedded in each of the first accommodation slot; two of the second magnets are provided, and one of the second magnet is embedded in each of the second accommodation slot.
